(19) United States
(12) Patent Application Publication
(10) Pub. No.: US 2026/0175844 A1
(43) Pub. Date: Jun. 25, 2026

(54) AUTOMATIC VEHICLE HOLD SYSTEM AND OPERATION

(71) Applicant: Ford Global Technologies, LLC, Dearborn, MI (US)

(72) Inventors: Jerry Alex James, Ypsilanti, MI (US); Donald A. Perlick, Farmington Hills, MI (US)

(73) Assignee: Ford Global Technologies, LLC, Dearborn, MI (US)

(21) Appl. No.: 18/989,238

(22) Filed: Dec. 20, 2024

(51) Int. Cl. B60W 30/182; B60W 30/18; B60W 50/08

(52) U.S. Cl. CPC B60W 30/182; B60W 30/18054; B60W 30/18063; B60W 30/18118; B60W 50/082; B60W 2520/30; B60W 2540/10; B60W 2540/12

(57) ABSTRACT

A computer has a processor and a memory storing instructions executable by the processor to: in response to a vehicle decelerating to a standstill, activate automatic vehicle hold mode to maintain the vehicle at the standstill. While the vehicle is at the standstill in the automatic vehicle hold mode, the instructions include instructions to: deactivate the automatic vehicle hold mode in response to depression of a brake pedal to a position that maintains the vehicle at the standstill after deactivation of the automatic vehicle hold mode; and then, deliver creep torque to wheels of the vehicle in two-pedal drive mode when the brake pedal and an accelerator pedal are both in a released position.

### BACKGROUND

Some vehicles are equipped with an automatic braking feature known as automatic vehicle hold. Such vehicles are operable in an automatic vehicle hold mode (AVH mode). With AVH mode activated, brake torque is automatically applied at wheels of the vehicle to maintain the vehicle at the standstill when the driver releases the brake pedal. When the operator of the vehicle takes action to accelerate the vehicle from the standstill (e.g., depressing an accelerator pedal), the brake torque is released so that control of acceleration and deceleration is restored to the operator by use of the accelerator pedal and the brake pedal. Some vehicles are equipped so that vehicle speed may be controlled by operation of one-pedal mode (i.e., one-pedal driving mode) in which the vehicle can be controlled using only the accelerator pedal to both accelerate and decelerate the vehicle. In one-pedal mode, the vehicle may be accelerated by depressing the accelerator pedal and decelerated by releasing the accelerator pedal. When the operator releases the accelerator pedal without depression of the brake pedal, the vehicle decelerates by regenerative braking in one-pedal mode. When the vehicle is decelerated to a standstill in one-pedal mode without depression of the brake pedal, AVH mode may be activated to maintain the vehicle at the standstill until the accelerator pedal is depressed.

### BRIEF DESCRIPTION OF THE DRAWINGS

FIG. 1 is a block diagram of components of a vehicle.

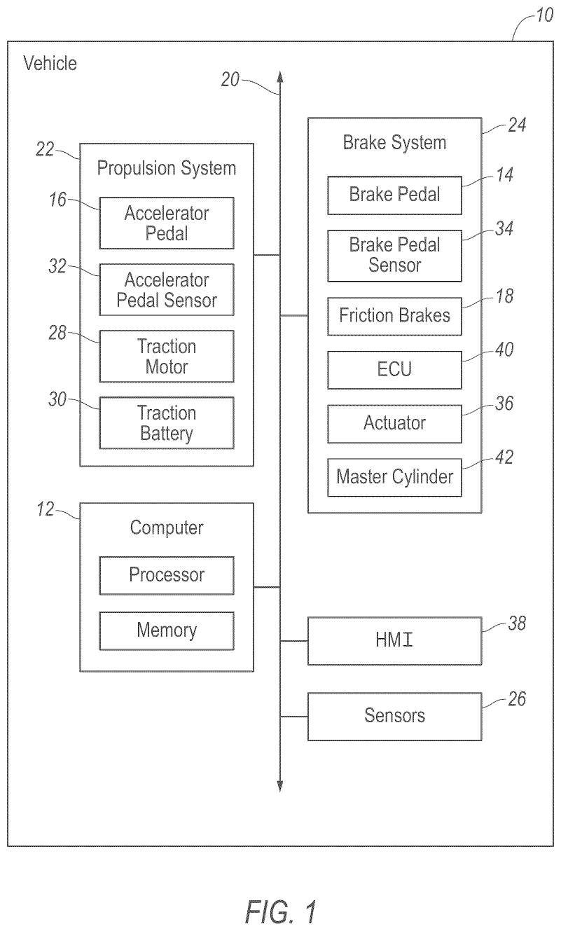

FIG. 2 is a flow chart for an example method.

FIG. 3 is a flow chart for another example method.

### DETAILED DESCRIPTION

A computer has a processor and a memory storing instructions executable by the processor to: in response to a vehicle decelerating to a standstill, activate automatic vehicle hold mode to maintain the vehicle at the standstill. The instructions include instructions to, while the vehicle is at the standstill in the automatic vehicle hold mode: deactivate the automatic vehicle hold mode in response to depression of a brake pedal to a position that maintains the vehicle at the standstill after deactivation of the automatic vehicle hold mode; and then, deliver creep torque to wheels of the vehicle in two-pedal drive mode when the brake pedal and an accelerator pedal are both in a released position.

The instructions may include instructions to deactivate the automatic vehicle hold mode include instructions to: determine the minimum depression point of the brake pedal to maintain the vehicle at the standstill after deactivation of the automatic vehicle hold mode; and compare the position of the brake pedal to the minimum depression point. The minimum depression point may be based on an incline of the vehicle. The minimum depression point may be based on a magnitude of creep torque delivered to the wheels.

The instructions may include instructions to, while the vehicle is in automatic vehicle hold mode, deactivate the automatic vehicle hold mode in response to depression of the accelerator pedal.

The instructions may include instructions to require input from a human-machine interface to deactivate the automatic vehicle hold mode while the vehicle is in the automatic vehicle hold mode.

The instructions may include instructions to, while the vehicle is at the standstill in automatic vehicle hold mode and one-pedal mode, deactivate the automatic vehicle hold mode and activate one-pedal mode in response to depression of the accelerator pedal.

The instructions to activate automatic vehicle hold mode to maintain the vehicle at the standstill may include instructions to activate automatic vehicle hold mode to maintain the vehicle at the standstill while the vehicle is in one-pedal mode. The instructions may include instructions to deactivate the one-pedal mode in response to the depression of the brake pedal to a position that maintains the vehicle at the standstill after deactivation of the automatic vehicle hold mode. The instructions may include instructions to, while the vehicle is in automatic vehicle hold mode and one-pedal mode, deactivate the automatic vehicle hold mode and activate one-pedal mode in response to depression of the accelerator pedal.

The instructions may include instructions to prevent the deactivation of the automatic vehicle hold mode in response to depression of the brake pedal when the vehicle is on an incline greater than a threshold.

The instructions may include instructions to decelerate the vehicle to a standstill in response to release of the accelerator pedal while the vehicle is in one-pedal mode.

The instructions may include instructions to decelerate the vehicle to a standstill in response to depression of the brake pedal.

A method includes, in response to a vehicle decelerating to a standstill, activating automatic vehicle hold mode to maintain the vehicle at the standstill. The method includes, while the vehicle is at the standstill in the automatic vehicle hold mode: deactivating the automatic vehicle hold mode in response to depression of a brake pedal to a position that maintains the vehicle at the standstill after deactivation of the automatic vehicle hold mode; and then, deliver creep torque to wheels of the vehicle in two-pedal drive mode when the brake pedal and an accelerator pedal are both in a released position.

Deactivating the automatic vehicle hold mode may include: determining the minimum depression point of the brake pedal to maintain the vehicle at the standstill after deactivation of the automatic vehicle hold mode; and comparing the position of the brake pedal to the minimum depression point. The minimum depression point may be based on an incline of the vehicle.

The method may include deactivating the automatic vehicle hold mode in response to depression of the accelerator pedal while the vehicle is in automatic vehicle hold mode.

The method may include, while the vehicle is at the standstill in automatic vehicle hold mode and one-pedal mode, deactivating the automatic vehicle hold mode and activate one-pedal mode in response to depression of the accelerator pedal.

Activating automatic vehicle hold mode to maintain the vehicle at the standstill may include activating automatic vehicle hold mode to maintain the vehicle at the standstill while the vehicle is in one-pedal mode. The method may include deactivating the one-pedal mode in response to the depression of the brake pedal to a position that maintains the vehicle at the standstill after deactivation of the automatic vehicle hold mode.

The method may include, while the vehicle is in automatic vehicle hold mode and one-pedal mode, deactivating the automatic vehicle hold mode and activate one-pedal mode in response to depression of the accelerator pedal.

The method may include preventing the deactivation of the automatic vehicle hold mode in response to depression of the brake pedal when the vehicle is on an incline greater than a threshold.

With reference to the Figures, wherein like numerals indicate like parts throughout the several views, a computer 12 of a vehicle 10 (i.e., a vehicle computer 12) has a processor and a memory storing instructions executable by the processor to, in response to the vehicle 10 decelerating to a standstill, activate automatic vehicle hold (AVH) mode to maintain the vehicle 10 at the standstill. The instructions include instructions to, while the vehicle 10 is at the standstill in the AVH mode: deactivate the AVH mode in response to depression of a brake pedal 14 to a position that maintains the vehicle 10 at the standstill after deactivation of the AVH mode; and, then, deliver creep torque to wheels of the vehicle 10 in two-pedal drive mode when the brake pedal 14 and an accelerator pedal 16 are both in a released position.

The deactivation of the AVH mode in response to suitable depression of the brake pedal 14 allows the vehicle operator (i.e., a human operator) to quickly and easily deactivate AVH mode and allow for creep torque in two-pedal drive mode as the brake pedal 14 is released. The quick and easy availability of allowing for creep torque can be a welcomed feature by certain vehicle operators in certain situations. As an example, in an example in which the operator seeks to enter a parking spot or perform another tight maneuver from a standstill, the release of AVH mode and the application of creep torque, as controlled by application of brake torque by the operator with use of the brake pedal 14, may provide at least a perceived increase in control of the acceleration and deceleration of the vehicle 10 during the tight maneuver. Since the brake pedal 14 is depressed to a position that maintains the vehicle 10 at the standstill, the handoff from AVH mode to the application of creep torque in to two-pedal drive mode is seamless. Specifically, during the operation of the vehicle 10, such as tight maneuvers, when the AVH mode is deactivated in response to such depression of the brake pedal 14, when AVH mode is deactivated, the vehicle 10 is maintained at the standstill by the brake torque applied by the depression of the brake pedal 14. The brake torque may be applied by friction brakes 18 at the wheels operable by depression of the brake pedal 14. The operator is then free to partially or fully release the brake pedal 14 to release brake torque and allow movement of the vehicle 10 by creep torque to perform a tight maneuver at the low speeds generated by the creep torque. In the event the operator chooses, instead of depressing the brake pedal 14, to accelerate the vehicle 10 by depression of the accelerator pedal 16, the depression of the accelerator pedal 16 deactivates AVH mode, in which case AVH mode may continue to be enabled so as to be activated at the next instance of the vehicle 10 decelerating to a standstill. Throughout this text, standstill refers to the vehicle 10 being stopped, with a velocity of zero, and the wheels of the vehicle 10 stationary (i.e., not spinning).

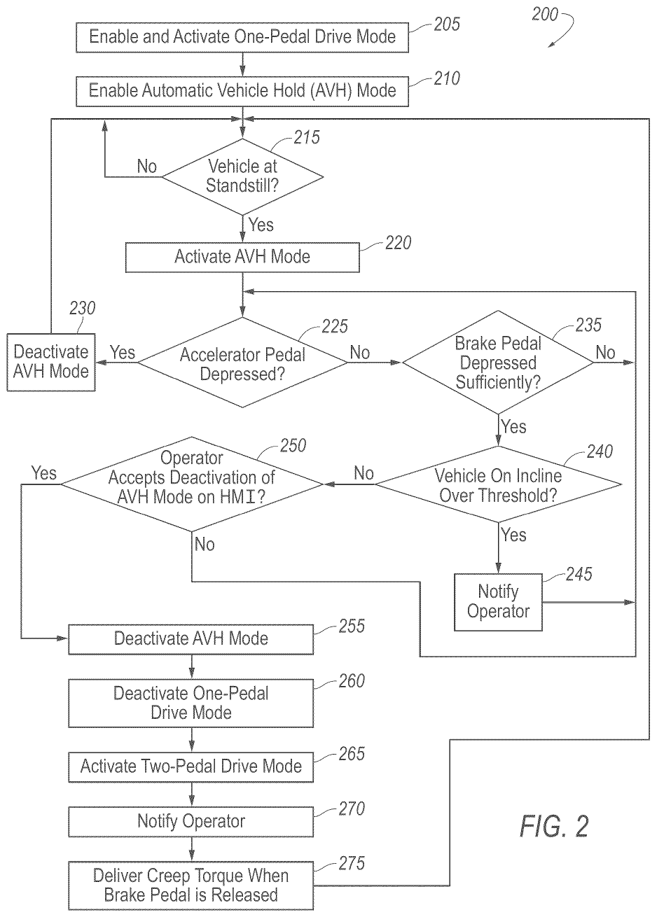

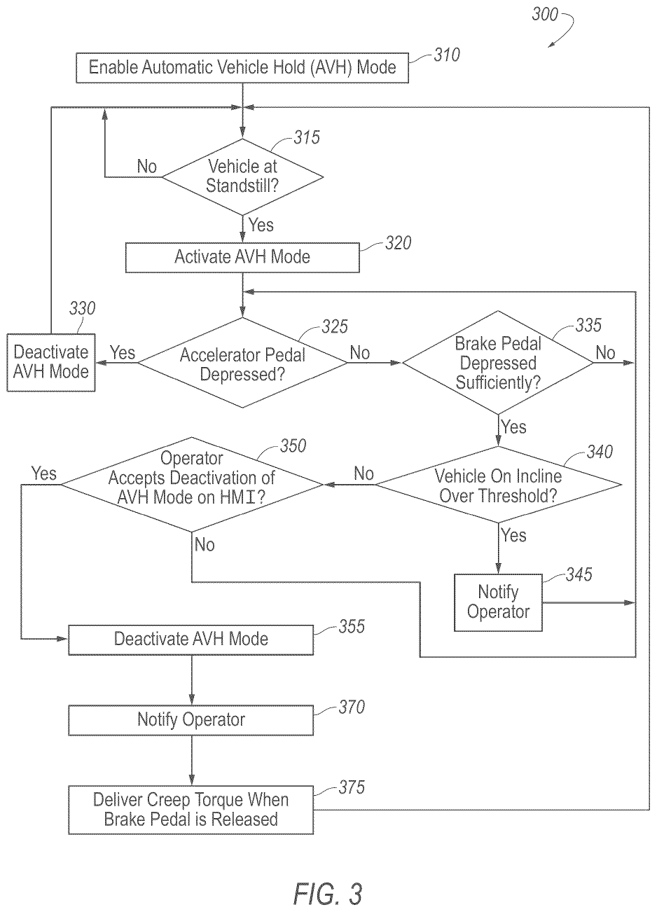

In some examples, including in the example method 200 shown in FIG. 2, the vehicle 10 may be operable in one-pedal drive mode. In such examples, the vehicle 10 may be decelerated to a standstill by releasing the accelerator pedal 16. In such examples, when AVH mode is enabled, the AVH mode is activated in response to the vehicle 10 decelerating to the standstill. In such examples, the AVH mode is enabled and activated and the one-pedal drive mode is enabled and activated. In the event the operator depresses the accelerator pedal 16, AVH mode is deactivated and the vehicle 10 accelerates in one-pedal drive mode. On the other hand, with the vehicle 10 at the standstill with AVH mode activated, in the event the operator depresses the brake pedal 14 to a position that maintains the vehicle 10 at the standstill after deactivation of the AVH mode, AVH mode and one-pedal drive mode are deactivated (and both may remain enabled) and two-pedal drive mode is activated, in which creep torque is delivered to wheels of the vehicle 10 allowing the vehicle 10 to creep as the brake pedal 14 is released. In other examples, including the example method 300 shown in FIG. 3, the vehicle 10 may be operable in two-pedal mode and decelerated to a standstill by depressing the brake pedal 14 to activate AVH mode.

The vehicle 10 may be any passenger or commercial automobile such as a car, a truck, a sport utility vehicle, a crossover, a van, a minivan, a taxi, a bus, etc. The vehicle 10 includes a system including the vehicle computer 12. The vehicle computer 12 may be a microprocessor-based computing device, e.g., a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit.

The vehicle computer 12 can include a processor, a memory, etc. The memory of the vehicle computer 12 can include media for storing instructions executable by the processor as well as for electronically storing data and/or databases, and/or the vehicle computer 12 can include structures such as the foregoing by which programming is provided. The vehicle computer 12 can be multiple computers coupled together.

The vehicle computer 12 may transmit and receive data through a communications network 20 such as a controller area network (CAN) bus, Ethernet, WiFi, Local Interconnect Network (LIN), onboard diagnostics connector (OBD-II), and/or by any other wired or wireless communications network. The vehicle computer 12 may be communicatively coupled to a propulsion system 22, a brake system 24, a steering system, sensors 26, the accelerator pedal 16, the brake pedal 14, and other components via the communications network.

The propulsion system 22 of the vehicle 10 generates energy and translates the energy into motion of the vehicle 10. The propulsion system 22 may include an automatic transmission. The propulsion system 22 may be a conventional vehicle propulsion system 22, for example, a conventional powertrain including an internal-combustion engine coupled to a transmission that transfers rotational motion to wheels; an electric powertrain including traction batteries and one or more electric motors, i.e., a traction motor 28, that transfer rotational motion to wheels of the vehicle 10; a hybrid powertrain including elements of the conventional powertrain and the electric powertrain; or any other type of propulsion. The propulsion system 22 can include an electronic control unit (ECU) or the like, e.g., a powertrain control module, that is in communication with and receives input from the computer 12 and/or a human driver. In some examples, the computer 12 may be the powertrain control module or a component of the powertrain control module. The operator of the vehicle 10 may control the propulsion system 22 via, e.g., the accelerator pedal 16, the brake pedal 14, etc.

In examples in which the propulsion system 22 is an electric powertrain or a hybrid powertrain, the propulsion system 22 may include a traction motor 28. In such an example, each traction motor 28 transfers rotational motion to one or more wheels based on input from the communications network 20, e.g. from the powertrain control module. In some examples, the traction motors 28 may be a known type. For example, the traction motor 28 may be of a known type for propulsion of the vehicle 10 in an electric or hybrid vehicle 10. The wheel transmits rotation from the traction motor 28 to the ground to propel the vehicle 10. The wheel may include a rim and a tire, as is known. In some examples, the traction motor 28 may drive an axle. In other examples, the traction motor 28 may be a wheel hub motor that drives an individual wheel.

The propulsion system 22 may include the accelerator pedal 16 to control the operation of the rest of the propulsion system 22. The accelerator pedal 16 provides input to the computer 12 indicating a position of the accelerator pedal 16 for use in controlling the propulsion system 22 and/or the brake system 24. The accelerator pedal 16 is positioned to be pressable by an operator of the vehicle 10. In some examples, the accelerator pedal 16 is at a floor of the vehicle 10 for control by a foot of a human driver. In other examples, the accelerator pedal 16 may be in other locations in the interior of the vehicle 10, e.g., a paddle on the steering wheel.

The traction motor 28 is operably coupled to one or more wheels of the vehicle 10. A gearbox (not shown) may be included to change a speed ratio between the traction motor 28 and the respective wheel. The traction motor 28 is capable to provide a positive torque to propel the vehicle 10 and may be capable of acting as a generator to provide a negative torque to brake the vehicle 10 such as via regenerative braking. The traction motor 28 may be a permanent magnet three-phase alternating current (AC) electric motor or other suitable type.

The traction motor 28 is powered by one or more traction batteries. The traction battery 30 stores energy that can be used by the traction motor 28. The traction battery 30 may provide a high-voltage direct current (DC) output from one or more battery cell arrays, sometimes referred to as battery cell stacks, within the traction battery 30. The battery cell arrays include one or more battery cells. The battery cells, such as a prismatic, pouch, cylindrical, or any other type of cell, convert stored chemical energy to electrical energy. The battery cells may include a housing, a positive electrode (cathode), and a negative electrode (anode). An electrolyte allows ions to move between the anode and cathode during discharge, and then return during recharge. Terminals may allow current to flow out of the battery cell for use by the vehicle 10. Different battery pack configurations may be available to address individual vehicle variables including packaging constraints and power requirements. The battery cells may be thermally adjusted with a thermal management system.

The traction battery 30 may be electrically connected to one or more power-electronics modules, e.g., the powertrain control module, through one or more contactors. The module may be electrically connected to the traction motor 28 and may provide the ability to bi-directionally transfer electrical energy between the traction battery 30 and the traction motor 28. For example, a traction battery 30 may provide a DC voltage while the traction motor 28 may require a three-phase AC. The power-electronics module may convert the DC voltage to a three-phase AC voltage as required by the traction motor 28. In a generator mode, which may be during regenerative braking, the power-electronics module may convert the three-phase AC voltage from the traction motor 28 acting as a generator to the DC voltage required by the traction battery 30.

The accelerator pedal 16 has a range of travel from a released position to a fully depressed position and positions therebetween. The released position may be considered a zero percent position and the fully depressed position may be considered a 100 percent position. The accelerator pedal 16 is at the zero percent position when the accelerator pedal 16 is released. Releasing the accelerator pedal 16 may be referred to as decreasing the accelerator pedal 16 position, and depressing the accelerator pedal 16 may be referred to as increasing the accelerator pedal 16 position. The propulsion system 22 may include an accelerator pedal sensor 32 that senses the position of the accelerator pedal 16. The sensor 32 is configured to output a pedal-position signal that is indicative of a sensed position of the accelerator pedal 16, i.e., an accelerator pedal position. The accelerator pedal 16 is used by the operator to command a desired vehicle speed and/or wheel torque. That is, the accelerator pedal 16 is used by the operator to set an operator-demanded torque. The operator-demanded torque may be a positive value or a negative value. A positive value indicates a propulsion torque, whereas a negative value indicates a braking torque. (A negative operator-demanded torque may also be referred to herein as “a target braking torque.”)

The computer 12 may be programmed to receive the pedal-position signal and determine the operator-demanded torque based on pedal position and other factors such as vehicle speed. In one-pedal driving mode, the accelerator pedal 16 is used to set a target vehicle propulsion torque when the operator-demanded torque is positive as well as, in one-pedal driving mode, a target braking torque when the driver-demanded torque is negative. The computer 12 may include multiple lookup tables or maps for determining the operator-demanded torque.

In two-pedal driving mode, the vehicle operator controls the vehicle speed by depressing and releasing the accelerator pedal 16 and brake pedal 14. The operator depresses the accelerator pedal 16 to accelerate the vehicle 10 and releases the accelerator pedal 16 and/or depresses the brake pedal 14 to decelerate the vehicle 10. In one-pedal driving mode, the vehicle 10 is controlled using the accelerator pedal 16 to both accelerate and decelerate the vehicle 10 without use of the brake pedal 14. In the one-pedal driving mode, the driver commands a raw operator-demanded wheel torque by depressing the accelerator pedal 16. Depending upon the vehicle speed and the accelerator pedal 16 position the raw operator-demanded torque may be a positive value or a negative value. A positive value indicates a propulsion torque, whereas a negative value indicates a braking torque. (A negative propulsion-demanded torque may also be referred to herein as “a target braking torque.”). The vehicle 10 may provide the target braking torque using either the powertrain, e.g., regenerative braking, the friction brakes 18, or a combination of both.

AVH mode can be enabled or disabled when the vehicle 10 is in two-pedal driving mode. When the vehicle 10 is in two-pedal driving mode and AVH mode is disabled or deactivated, the vehicle 10 drive at a slow speed when the accelerator pedal 16 and the brake pedal 14 are released (i.e., at zero percent position). This is called creep. Creep torque, which moves the vehicle at a creep, is supplied to the wheels from the powertrain system. In some examples, the creep torque may result from torque in mechanical components of the drive train, e.g., in automatic transmissions. In other examples, creep torque may be electronically generated to mimic the level of creep torque typically applied by mechanical components of the drive train, e.g., by electrically activating traction motors 28 to deliver creep torque at the appropriate situation.

The one-pedal drive mode may be configured to bring the vehicle 10 to a standstill when the driver has released the accelerator pedal 16 without application of the brake pedal 14. The vehicle 10 may be decelerated to a standstill using regenerative braking, friction braking, or both. In examples in which AVH mode is enabled, the AVH mode is activated and the friction brakes 18 are applied when the vehicle 10 is decelerated to a standstill to maintain the vehicle 10 at the standstill.

In both one-pedal drive mode and two-pedal drive mode, when AVH mode is active and the vehicle 10 is decelerated to a standstill, the computer 12 operates the friction brakes 18 to maintain the vehicle 10 at the standstill as long as the accelerator pedal 16 and the brake pedal 14 are in the released positions. In other words, when the vehicle 10 is at a standstill, the vehicle 10 remains at a standstill, and does not move from creep torque, until the computer 12 receives an input from the accelerator pedal 16 or the brake pedal 14. to accelerate.

The brake system 24 resists the motion of the vehicle 10 to decelerate the vehicle 10 using friction brakes 18 operable by depression of the brake pedal 14. The brake system 24 slows or stops rotation of the wheels relative to the ground. The friction brakes 18 apply brake torque to the wheels of the vehicle 10. In some examples, the brake system 24 may engage components of the wheels to slow or stop the spinning of the wheels, e.g., may include friction brakes 18 such as disc brakes, drum brakes, band brakes, etc. The friction brakes 18 are controlled by depression of the brake pedal 14. Specifically, the brake pedal 14 is depressed to generate friction with components rotatable with the wheel to generate brake torque to slow the rotation of the wheel. For example, the depression of the brake pedal 14 actuates a brake pad against a brake rotor, a brake shoe against drum, etc., when the wheel is spinning to slow rotation of the wheel.

The brake system 24 includes the brake pedal 14 to provide input to the vehicle computer 12 indicating a position of the brake pedal 14 for use in controlling the friction brakes 18 of the brake system 24. The brake pedal 14 is positioned so that an operator of the vehicle 10 can selectively depress the brake pedal 14. The brake pedal 14 is movable relative to the body of the vehicle 10, e.g., is coupled by a hinge to the body of the vehicle 10. The brake has a range of motion, e.g., an angular range of motion around the hinge. The position of the brake pedal 14 within the range of motion is reported to the computer 12. In some examples, the brake pedal 14 is at a floor of the vehicle 10 for control by a foot of a human driver. In other examples, the brake pedal 14 may be in other locations in the interior of the vehicle 10, e.g., a paddle on the steering wheel.

The brake pedal 14 has a range of travel from a released position to a fully depressed position and positions therebetween. In examples in which the brake pedal 14 is hinged to the body of the vehicle, the depression of the brake pedal 14 is the rotation of the brake pedal 14 about the hinge. The released position may be considered a zero percent position and the fully depressed position may be considered a 100 percent position. The brake pedal 14 is at the zero percent position when the brake pedal 14 is released. Releasing the brake pedal 14 may be referred to as decreasing the brake pedal 14 position, and depressing the brake pedal 14 may be referred to as increasing the brake pedal 14 position. The amount of brake torque generated at the wheel corresponds to the depressed position of the brake pedal 14, with maximum brake torque at the 100 percent position and decreasing brake torque at decreased depression. The brake pedal 14 is selectively depressed by the operator between the zero percent position and the 100 percent position to command a desired brake torque at wheels of the vehicle 10.

In some examples, the vehicle 10 includes may be regenerative brakes. As set forth above, in some examples, the traction motor 28 may brake the respective wheel. In such an example, a component of the traction motor 28 slows or stops rotation of the respective wheel relative to the ground. Components of the brake system 24 may be of any suitable type of brakes, including, in some examples, those that are known. The brake system 24 may additionally include a parking brake operable to prevent movement of the vehicle 10 when the vehicle 10 is in a Park setting (e.g., a gear shifter is in “Park” to place a transmission of the vehicle 10 in Park).

The brake system 24 may be a hydraulic system, an electric system, or a combination of electric and hydraulic to actuate the friction brakes 18. In a hydraulic system, depression of the brake pedal 14 actuates a master cylinder to pressurize brake fluid in the hydraulic system to actuate the friction brakes 18. The master cylinder actuates the friction brakes 18 by controlling the pressure level at the friction brakes 18. The brake system 24 may be a brake-by-wire system that uses brake pedal sensors 34 and actuators 36 to engage the friction brakes 18 rather than a direct mechanical connection between the brake pedal 14 and a master cylinder. In such examples, an electronic control unit 40 can provide input to the actuator 36 and/or the master cylinder 42 and actuate the master cylinder 42 based on the received data from the brake pedal sensors 34 indicating the position of the brake pedal 14. The brake pedal sensors 34 are configured to sense movement of the brake pedal 14 and output a signal indicative of this movement. The signals include data indicative of a position of the brake pedal 14, which may be expressed as a percentage of depression, i.e., between the zero percent position and the 100 percent position. The brake system 24 can include an electronic control unit (ECU) or the like, e.g., a brake control module, that is in communication with and receives input from an operator of the vehicle 10. In some examples, the computer 12 may be the brake control module or a component of the brake control module.

The vehicle 10 may include a human machine interface (HMI) 38 for manually controlling features of the vehicle 10, including activating and deactivating one-pedal driving mode, activating and deactivating AVH mode, etc. The HMI 38 may be located, for example, on an instrument panel in a passenger cabin of the vehicle 10. The HMI 38 may include dials, digital readouts, screens, speakers, and so on for providing information to the occupant. The HMI 38 may include buttons, knobs, keypads, microphone, etc., for receiving information from the operator As an example, the vehicle 10 may include a touchscreen with various menus and setting selections that may be selected, e.g., by touching an icon on the touchscreen. One of these setting selections may be for activation or deactivation of one-pedal driving and one of these setting selections may be for activation or deactivation of AVH mode.

The vehicle 10 includes sensors 26 that provide data about operation of the vehicle 10, for example, vehicle speed, wheel speed, vehicle incline (i.e., incline of the ground on which the wheels rest), wheel orientation, and engine and transmission data (e.g., temperature, fuel consumption, etc.). The sensors 26 may detect the location and/or orientation of the vehicle 10. For example, the sensors 26 may include global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. The sensors 26 may detect the external world, e.g., objects and/or characteristics of surroundings of the vehicle 10, such as other vehicles, road lane markings, traffic lights and/or signs, etc. For example, the sensors 26 may include radar sensors, ultrasonic sensors, scanning laser range finders, light detection and ranging (lidar) devices, and image processing sensors such as cameras. In some examples, the sensors 26 may detect an incline angle of the vehicle 10 due to uneven or sloped ground, e.g., a hill, on which the wheels of the vehicle 10 rest.

As set forth above, the vehicle computer 12 is programmed to (i.e., has a processor and a memory storing instructions executable by the processor to) activate and deactivate the AVH mode in response to inputs and to perform the methods described herein, including the method 200 shown in FIG. 2 and the method 300 shown in FIG. 3. Use of “in response to” and “based on” herein indicates a causal relationship, not merely a temporal relationship. When a feature (e.g., one-pedal mode and AVH mode) is enabled, the feature is in condition for use and available for use, and when a feature is disabled, the feature is not in condition for use and/or not available for use. When a feature is activated, the feature is on, i.e., is performing an action. When a feature is deactivated, the feature is off, i.e., is not performing an action. Thus, a feature may be enabled but deactivated, in which case the feature is available to be activated in response to requisite input.

The computer 12 is programmed to, in response to a vehicle 10 decelerating to a standstill, activate AVH mode to maintain the vehicle 10 at the standstill. Specifically, once the AVH mode is activated, the computer 12 applies the friction brakes 18 to exert sufficient braking torque to prevent rotation of the wheels, and the computer 12 maintains this braking torque until the AVH mode is deactivated. Specifically, the computer 12 instructs a component to actuate the friction brakes 18. For example, in examples in which the brake system 24 includes an actuator 36 and a master cylinder 42 controlled by the actuator 36, the computer 12 may instruct the electronic control unit 40 to pressurize hydraulic lines to actuate the friction brakes 18 to exert brake torque sufficient to maintain the vehicle 10 at a standstill.

The vehicle 10 may be decelerated to the standstill with the release of the accelerator pedal 16 and/or the depression of the brake pedal 14. The computer 12 may be programmed to decelerate the vehicle 10 to the standstill based on input from the accelerator pedal 16 and/or the brake pedal 14. For example, when the vehicle 10 is in two-pedal drive mode, the vehicle 10 may be decelerated to the standstill by releasing the accelerator pedal 16 and depressing the brake pedal 14 to exert sufficient brake torque to decelerate the vehicle 10 to a standstill. When the vehicle 10 is in one-pedal drive mode, the vehicle 10 may be decelerated to the standstill by releasing the accelerator pedal 16, which brings the vehicle 10 to a standstill as described above.

When the AVH mode is activated, whether the vehicle 10 is in one-pedal driving mode or two-pedal driving mode, the computer 12 is programmed so that AVH mode can be manually deactivated by the operator of the vehicle 10 by depressing the brake pedal 14 a sufficient amount or by depressing the accelerator pedal 16. In the event the operator chooses to accelerate the vehicle 10 by depression of the accelerator pedal 16 while in AVH mode, the depression of the accelerator pedal 16 deactivates AVH mode, in which case AVH mode may continue to be enabled so as to be activated at the next instance of the vehicle 10 decelerating to a standstill. For example, in the example in which the depression of the accelerator pedal 16 is detected by the sensor 32 (described above), the sensor 32 outputs a pedal-position signal that is indicative of a sensed position of the accelerator pedal 16 to the computer 12 to accelerate the vehicle 10 and control the vehicle speed and/or wheel torque.

In addition to being programmed to deactivate the AVH mode in response to depression of the accelerator pedal 16, the computer 12 is programmed to, while the vehicle 10 is at the standstill in the AVH mode, deactivate the AVH mode in response to sufficient depression of the brake pedal 14 (described further below). In such an instance, the computer 12 is programmed to then activate two-pedal mode in which creep torque is delivered to wheels of the vehicle 10 when the brake pedal 14 and the accelerator pedal 16 are both in a released position. Since the brake pedal 14 is depressed to a position that maintains the vehicle 10 at the standstill, the operator is free to partially or fully release the brake pedal 14 to release brake torque and allow movement of the vehicle 10 by creep torque to perform a tight maneuver at the low speeds generated by the creep torque.

As set forth above, while the vehicle 10 is at the standstill in the AVH mode, the computer 12 is programmed to deactivate the automatic vehicle hold mode in response to depression of the brake pedal 14 to a position that maintains the vehicle 10 at the standstill after deactivation of the automatic vehicle hold mode. The computer 12 may be programmed to calculate a minimum depression point of the brake pedal 14 based on input data and/or sensed data. The minimum depression point of the brake pedal 14 is the threshold to which the brake pedal 14 must be depressed to maintain the vehicle 10 at the standstill when AVH mode is deactivated. In other words, in the hypothetical event the brake pedal 14 is depressed to a position less than the minimum depression point, the vehicle 10 would move by gravity, creep torque, etc., if AVH mode were deactivated. The minimum depression point may correspond to position between the zero percent position and the 100 percent position described above. In examples in which the brake pedal 14 is hinged to the body of the vehicle, the minimum depression point may be a rotational position of the brake pedal 14 about the hinge.

After the minimum depression point is calculated, the position of the brake pedal 14 relative to the minimum depression point may be calculated. For example, in the example in which the brake system 24 includes the master cylinder 42 and pedal sensor 34 indicating the position of the brake pedal 14, the brake pedal sensor 34 is configured to sense movement of the brake pedal 14 and output a signal indicative of this movement. Using the signal indicating the position of the brake pedal 14, the computer 12 may compare the position of the brake pedal 14 relative to the minimum depression point to determine whether the brake pedal 14 is depressed beyond the minimum depression point to maintain the vehicle 10 at the standstill in the event AVH mode is deactivated.

The computer 12 may calculate or access data identifying the brake torque necessary to maintain the vehicle 10 at the standstill, and the computer 12 may then identify the minimum depression point to generate that brake torque. The computer 12 may identify the brake torque necessary to maintain the vehicle 10 at the standstill based on incline of the vehicle 10 based on uneven or sloped ground on which the wheels rest, e.g., as measured by the one or more sensors 26 of the vehicle 10 (such as an inertial measurement unit of the vehicle 10 in some examples). When at a non-zero incline, brake torque acts against gravitational forces. The computer 12 may determine the brake torque to overcome the gravitational force at a given incline angle, e.g., a lookup table, collection of recent historical data, etc., and the computer 12 uses this brake torque to determine the minimum depression point. As another example, the computer 12 may identify the brake torque necessary to maintain the vehicle 10 at the standstill based on a magnitude of creep torque delivered to the wheels. The computer 12 may determine the brake torque to overcome the creep torque, and the computer 12 determines the minimum depression point based on this brake torque.

After determining the brake torque necessary to maintain the vehicle 10 at the standstill, the computer 12 determines the minimum depression point. As an example, the computer 12 may access historical data collected by the vehicle 10 identifying correspondence of brake torque and brake pedal 14 position, e.g., curve showing brake torque versus brake pedal 14 position. In such an example, the computer 12 identifies the minimum depression point as the position of the brake pedal 14 that generates the brake torque necessary to maintain the vehicle 10 at the standstill.

In some examples, the computer 12 is programmed to prevent the deactivation of the AVH mode in response to depression of the brake pedal 14 when the vehicle 10 is on an incline greater than a threshold. As set forth above, the incline of the vehicle 10 may be detected by a sensor 26, e.g., an IMU, which can communicate the incline to the computer 12. In the event the magnitude of the incline of the vehicle 10 while at the standstill exceeds the magnitude of the threshold, the computer 12 does not deactivate the AVH mode in response to depression of the brake pedal 14. In such examples, the force of gravity on the vehicle 10 may exceed the creep torque in a hypothetical event in which the AVH mode is deactivated, such that the vehicle 10 would not creep in two-pedal drive mode when the accelerator pedal 16 and the brake pedal 14 are released. As an example, the threshold may be a fixed magnitude, e.g., +/−3 degrees. In other examples, the threshold may be calculated based on inputs to the computer 12, e.g., an active calculation of the incline angle at which creep torque would exceed gravitational forces and creep the vehicle 10 in the event AVH mode is disabled.

The computer 12 may be programmed to require input from the HMI 38 to deactivate the AVH mode while the vehicle 10 is in the AVH mode. In other words, in the event AVH mode is enabled, the vehicle 10 is at a standstill, the computer 12 may require, in addition to sufficient depression of the brake pedal 14, input from the operator to the HMI 38 to deactivate the AVH mode. For example, in such a situation, the sufficient depression of the brake pedal 14 may initiate a visual prompt on the HMI 38, such as touchscreen button, to confirm deactivation of the AVH mode. In such an example, the operator of the vehicle 10 may touch the button to deactivate AVH mode. In the event the operator does not touch the button, the vehicle 10 does maintains the AVH mode as active and the friction brakes 18 continue to maintain brake torque to maintain the vehicle 10 at the standstill.

The computer 12 may be programmed to inform the user through HMI 38 that AVH mode has been deactivated. For example, the computer 12 may be programmed to provide a visual indication on a screen and/or an audible indication that can be perceived by the operator of the vehicle 10.

In an example in which the vehicle 10 is equipped to operate in one-pedal driving mode, and one-pedal driving mode is enabled and activated, the computer 12 may be programmed to decelerate the vehicle 10 to a standstill in response to release of the brake pedal 14. In the event the AVH mode is enabled, the AVH mode is activated when the vehicle 10 is at the standstill. The computer 12 is programmed to deactivate AVH mode by either depression of the accelerator pedal 16 or sufficient depression of the brake pedal 14. Specifically, in the event the accelerator pedal 16 is depressed in such an example, one-pedal drive mode remains activated and the computer 12 controls acceleration and deceleration of the vehicle 10 based on input to the accelerator pedal 16 by the operator. In the event the brake pedal 14 is sufficiently depressed (as described above) in such an example, the computer 12 both deactivates the one-pedal drive mode and deactivates the AVH mode in response to the sufficient depression of the brake pedal 14. In such an event, the two-pedal driving mode is activated and creep torque is delivered to the wheels when the accelerator pedal 16 and the brake pedal 14 are released. Specifically, the depression of the brake pedal 14 sufficiently to deactivate AVH mode also maintains the vehicle 10 at the standstill when the AVH mode is deactivated, and the operator may release the brake pedal 14 to move the vehicle 10 with creep torque, e.g., the operator may slowly ease off the brake pedal 14 to allow controlled delivery of creep torque to the wheels.

When the AVH mode is deactivated, the computer 12 is programmed to deliver creep torque to wheels of the vehicle 10 in two-pedal drive mode when the brake pedal 14 and the accelerator pedal 16 are both in a released position. Specifically, in examples in which the vehicle 10 was in one-pedal drive mode, the computer 12 is programmed to deactivate the one-pedal drive mode and activate two-pedal drive mode in response to deactivation of the AVH mode by sufficient depression of the brake pedal 14. In examples in which the vehicle 10 was in two-pedal drive mode, the computer 12 is programmed to maintain the vehicle 10 in two-pedal drive mode when AVH mode is deactivated by sufficient depression of the brake pedal 14. In both examples, with the accelerator pedal 16 released, the computer 12 is programmed to release the friction brakes 18 in response to release of the brake pedal 14 to allow deliver of creep torque to the wheels of the vehicle 10 to move the vehicle 10 with creep torque.

In some examples, the computer 12 may be programmed to notify the operator, e.g., with visual and/or audible notification through the HMI 38, that the AVH mode has been deactivated by sufficient depression of the brake pedal 14 when the vehicle 10 was at the standstill. In examples in which the vehicle 10 was on one-pedal drive mode, the computer 12 may be programmed to notify the operator, e.g., with visual and/or audible notification through the HMI 38, that the one-pedal drive mode has been deactivated by sufficient depression of the brake pedal 14 when the vehicle 10 was the standstill.

The computer 12 may be programmed so that, after deactivation of the AVH mode by sufficient depression of the brake pedal 14 when the vehicle 10 is at a standstill, the AVH mode remains enabled so that AVH mode can again be activated in future operation, e.g., at the next deceleration of the vehicle 10 to a standstill. Similarly, in examples in which one-pedal drive mode is deactivated by sufficient depression of the brake pedal 14 when the vehicle 10 is at a standstill, the computer 12 is programmed to maintain the one-pedal drive mode as enabled so that one-pedal drive mode can again be activated in future operations, e.g., by input by the operator through the HMI 38.

With reference to FIG. 2, an example method 200 is shown. The computer 12 is programmed to perform the method 200. The example method 200 shown in FIG. 2 includes the activation of one-pedal drive mode. In other examples, including the example method 300 shown in FIG. 3, the computer 12 may perform a similar method with the vehicle 10 in two-pedal drive mode.

In block 205, the method 200 includes enabling and activating one-pedal drive mode. The one-pedal drive mode may be both enabled and activated in response to input by the operator, e.g., through the HMI 38. The input from the operator through the HMI 38 is communicated to the computer 12. When one-pedal drive mode is enabled and activated, the vehicle 10 operates in one-pedal drive mode as described above.

In block 210, the method 200 includes enabling AVH mode. The AVH mode may be enabled in response to input by the operator, e.g., through the HMI 38. The input from the operator through the HMI 38 is communicated to the computer 12. When AVH mode is enabled, AVH mode is available for activation and subsequent operation when certain conditions are met, as described above.

In block 215, the method 200 includes determining whether the vehicle 10 has decelerated to a standstill. As an example, the computer 12 may determine that the vehicle 10 is at a standstill based on input from the sensors 26 of the vehicle 10.

In response to detection of the vehicle 10 at the standstill, the method 200 includes activating AVH mode, as shown in block 220. When the computer 12 activates AVH mode, as described above, the computer 12 instructs the friction brakes 18 to maintain sufficient brake torque to prevent movement of the vehicle 10 from the standstill when the brake pedal 14 and the accelerator pedal 16 are released. In block 225, the method 200 includes deactivating the AVH mode when the accelerator pedal 16 is depressed, as shown in block 230. As described above, in such a scenario, the method 200 includes maintaining AVH mode as enabled for future activation. In examples in which one-pedal drive mode is activated, the depression of the accelerator pedal 16 in block 225 resumes operation of acceleration and deceleration of the vehicle 10 with the use of the accelerator pedal 16 in one-pedal drive mode, as described above.

The method 200 includes deactivating the AVH mode and delivering creep torque to the wheels in response to sufficient depression of the brake pedal 14 in blocks 235-275. In block 235, the method 200 includes determining whether the brake pedal 14 is depressed and depressed sufficiently (i.e., to a position that maintains the vehicle 10 at the standstill after deactivation of the automatic vehicle hold mode, as described above). The position of the brake pedal 14 may be detected with the pedal sensors of the brake system 24, as described above. In block 235, the method 200 includes determining the minimum depression point and comparing the position of the brake pedal 14 with the minimum depression point, as described above.

With reference to block 240, in the event that the brake pedal 14 is depressed sufficiently, the method 200 includes determining whether the vehicle 10 is at an incline for which the AVH mode can be deactivated and creep torque delivered, as described above. In the event the vehicle 10 is at an incline over a threshold, described above, then, in response to sufficient depression of the brake pedal 14, the method 200 includes notifying the operator that AVH mode cannot be deactivated at the present incline angle, as shown in block 245. The notification in block 245 may be provided to the operator, for example, through the HMI 38. In the event the incline is acceptable for deactivation of the AVH mode, the method 200 proceeds to block 250.

With reference to block 250, in some examples the method 200 includes request for operator acceptance of deactivation of AVH mode. Specifically, the method 200 in such examples includes confirmation in addition to the sufficient depression of the brake pedal 14 in block 235. As an example, block 250 may include requesting confirmation through the HMI 38. For example, after sufficient depression of the brake pedal 14 in block 235, the method 200 may include a visual and/or audible request for confirmation of deactivation of the AVH mode. The operator may provide acceptance through the HMI 38 by, for example, touching a touch screen, pushing a button, etc.

In response to input from the operator to deactivate the AVH mode in blocks 235 and 250, the method 200 includes deactivating AVH mode in block 255. As set forth above, deactivation of AVH mode returns control of the friction brakes 18 to the operation of the brake pedal 14, e.g., depression and release of the brake pedal 14 controls the friction brakes 18. Since the brake pedal 14 is depressed to a position that maintains the vehicle 10 at the standstill after deactivation of the AVH mode in block 255, the vehicle 10 remains at the standstill until the operator releases the brake pedal 14. The method 200 includes delivering creep torque to the wheels as the brake torque is released in response to release of the brake pedal 14, as shown in block 275. As set forth above, the operator may ease off the brake pedal 14 to ease into the delivery of creep torque. In block 270, the method 200 includes notifying the operator that AVH mode has been deactivated, e.g., through the HMI 38.

In examples, such as the example method 200 shown in FIG. 2, in which one-pedal drive mode is activated in block 210, the method 200 at block 260 includes deactivating one-pedal drive mode in response to the sufficient depression of the brake pedal 14 in block 235. In other words, in such examples, the sufficient depression of the brake pedal 14 in block 235 both deactivates the AVH mode in block 255 and deactivates the one-pedal drive mode in block 260. The deactivation of the AVH mode in block 255 and the deactivation of the one-pedal drive mode in block 260 may be simultaneous in some examples.

In examples, such as the example method 200 shown in FIG. 2, in which one-pedal drive mode is activated in block 210, the method 200 includes activating two-pedal mode in block 265. In other examples in which the vehicle 10 is operated in two-pedal drive mode at the time the vehicle 10 decelerates to the standstill in block 215, the method 200 includes maintaining the activation of the two-pedal drive mode in block 265. In the example shown in method 200 in which one-pedal drive mode is deactivated and two-pedal drive mode is activated, at block 270 the method 200 includes notifying the operator that the one-pedal drive mode has been deactivated and/or that the two-pedal drive mode has been activated, e.g., through the HMI 38.

With reference to block 275, after deactivation of AVH mode in block 255 and activation of two-pedal drive mode in block 265, the method 200 includes delivering creep torque to the wheels when the brake pedal 14 is released. As set forth above, the creep torque is delivered to the wheels as the brake torque is released in response to release of the brake pedal 14. As set forth above, the operator may ease off the brake pedal 14 to ease into the delivery of creep torque. The operator may control the amount of creep torque delivered to the wheels, as controlled by selective application of brake torque through the depression or release of the brake pedal 14, to move the vehicle 10 in a tight maneuver. The operator may also depress and release both the accelerator pedal 16 and the brake pedal 14 to control the acceleration and deceleration of the vehicle 10 during the tight maneuver. In such examples, creep torque is delivered to the wheels and the vehicle 10 moves by creep torque when the brake pedal 14 and the accelerator pedal 16 are released. In other words, the vehicle 10 operates in two-pedal drive mode after block 275 with control of acceleration, deceleration, and delivery of creep torque by depression and release of the brake pedal 14 and the accelerator pedal 16. In the event that one-pedal drive mode and/or AVH mode is activated after block 275, the method 200 returns to block 205 or 210 and the method 200 restarts.

With reference to FIG. 3, an example method 300 is shown. The computer 12 is programmed to perform the method 300. In block 310, the method 300 includes enabling AVH mode. The AVH mode may be enabled in response to input by the operator, e.g., through the HMI 38. The input from the operator through the HMI 38 is communicated to the computer 12. When AVH mode is enabled, AVH mode is available for activation and subsequent operation when certain conditions are met, as described above.

In block 315, the method 300 includes determining whether the vehicle 10 has decelerated to a standstill. In block 315, the vehicle 10 may be brought to a standstill by depressing the brake pedal 14 in two-pedal driving mode. In response to detection of the vehicle 10 at the standstill, the method 300 includes activating AVH mode, as shown in block 320.

The method 300 includes deactivating the AVH mode and delivering creep torque to the wheels in response to sufficient depression of the brake pedal 14 in blocks 335-375. In block 335, the method 300 includes determining whether the brake pedal 14 is depressed and depressed sufficiently (i.e., to a position that maintains the vehicle 10 at the standstill after deactivation of the automatic vehicle hold mode, as described above). In block 235, the method 200 includes determining the minimum depression point and comparing the position of the brake pedal 14 with the minimum depression point, as described above.

With reference to block 340, in the event that the brake pedal 14 is depressed sufficiently, the method 300 includes determining whether the vehicle 10 is at an incline for which the AVH mode can be deactivated and creep torque delivered, as described above. In the event the vehicle 10 is at an incline over a threshold, described above, then, in response to sufficient depression of the brake pedal 14, the method 300 includes notifying the operator that AVH mode cannot be deactivated at the present incline angle, as shown in block 345. The notification in block 345 may be provided to the operator, for example, through the HMI 38. In the event the incline is acceptable for deactivation of the AVH mode, the method 300 proceeds to block 350.

With reference to block 350, in some examples the method 300 includes request for operator acceptance of deactivation of AVH mode. In response to input from the operator to deactivate the AVH mode in blocks 335 and 350, the method 300 includes deactivating AVH mode in block 355. As set forth above, deactivation of AVH mode returns control of the friction brakes 18 to the operation of the brake pedal 14, e.g., depression and release of the brake pedal 14 controls the friction brakes 18. Since the brake pedal 14 is depressed to a position that maintains the vehicle 10 at the standstill after deactivation of the AVH mode in block 355, the vehicle 10 remains at the standstill until the operator releases the brake pedal 14. The method 300 includes delivering creep torque to the wheels as the brake torque is released in response to release of the brake pedal 14, as shown in block 375. As set forth above, the operator may ease off the brake pedal 14 to ease into the delivery of creep torque. In block 370, the method 300 includes notifying the operator that AVH mode has been deactivated, e.g., through the HMI 38.

In general, the computer 12 may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

The computer 12 generally includes computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer readable medium (also referred to as a processor readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A computer having a processor and a memory storing instructions executable by the processor to:
in response to a vehicle decelerating to a standstill, activate automatic vehicle hold mode to maintain the vehicle at the standstill; and
while the vehicle is at the standstill in the automatic vehicle hold mode:
deactivate the automatic vehicle hold mode in response to depression of a brake pedal to a position that maintains the vehicle at the standstill after deactivation of the automatic vehicle hold mode; and
then, deliver creep torque to wheels of the vehicle in two-pedal drive mode when the brake pedal and an accelerator pedal are both in a released position.

2. The computer as set forth in claim 1, wherein the instructions to deactivate the automatic vehicle hold mode include instructions to:
determine the minimum depression point of the brake pedal to maintain the vehicle at the standstill after deactivation of the automatic vehicle hold mode; and
compare the position of the brake pedal to the minimum depression point.

3. The computer as set forth in claim 2, wherein the minimum depression point is based on an incline of the vehicle.

4. The computer as set forth in claim 3, wherein the minimum depression point is based on a magnitude of creep torque delivered to the wheels.

5. The computer as set forth in claim 1, wherein the memory stores instructions executable by the processor to, while the vehicle is in automatic vehicle hold mode, deactivate the automatic vehicle hold mode in response to depression of the accelerator pedal.

6. The computer as set forth in claim 1, wherein the memory stores instructions executable by the processor to require input from a human-machine interface to deactivate the automatic vehicle hold mode while the vehicle is in the automatic vehicle hold mode.

7. The computer as set forth in claim 1, wherein the memory stores instructions executable by the processor to, while the vehicle is at the standstill in automatic vehicle hold mode and one-pedal mode, deactivate the automatic vehicle hold mode and activate one-pedal mode in response to depression of the accelerator pedal.

8. The computer as set forth in claim 1, wherein:
the instructions to activate automatic vehicle hold mode to maintain the vehicle at the standstill includes instructions to activate automatic vehicle hold mode to maintain the vehicle at the standstill while the vehicle is in one-pedal mode; and
the memory stores instructions executable by the processor to deactivate the one-pedal mode in response to the depression of the brake pedal to a position that maintains the vehicle at the standstill after deactivation of the automatic vehicle hold mode.

9. The computer as set forth in claim 8, wherein the memory stores instructions executable by the processor to, while the vehicle is in automatic vehicle hold mode and one-pedal mode, deactivate the automatic vehicle hold mode and activate one-pedal mode in response to depression of the accelerator pedal.

10. The computer as set forth in claim 1, wherein the memory stores instructions executable by the processor to prevent the deactivation of the automatic vehicle hold mode in response to depression of the brake pedal when the vehicle is on an incline greater than a threshold.

11. The computer as set forth in claim 1, wherein the memory stores instructions executable by the processor to decelerate the vehicle to a standstill in response to release of the accelerator pedal while the vehicle is in one-pedal mode.

12. The computer as set forth in claim 1, wherein the memory stores instructions executable by the processor to decelerate the vehicle to a standstill in response to depression of the brake pedal.

13. A method comprising:
in response to a vehicle decelerating to a standstill, activating automatic vehicle hold mode to maintain the vehicle at the standstill; and
while the vehicle is at the standstill in the automatic vehicle hold mode:
deactivating the automatic vehicle hold mode in response to depression of a brake pedal to a position that maintains the vehicle at the standstill after deactivation of the automatic vehicle hold mode; and
then, activate two-pedal mode in which creep torque is delivered to wheels of the vehicle when the brake pedal and an accelerator pedal are both in a released position.

14. The method as set forth in claim 13, deactivating the automatic vehicle hold mode includes:
determining the minimum depression point of the brake pedal to maintain the vehicle at the standstill after deactivation of the automatic vehicle hold mode; and
comparing the position of the brake pedal to the minimum depression point.

15. The method as set forth in claim 14, wherein the minimum depression point is based on an incline of the vehicle.

16. The method as set forth in claim 13, further comprising deactivating the automatic vehicle hold mode in response to depression of the accelerator pedal while the vehicle is in automatic vehicle hold mode.

17. The method as set forth in claim 13, further comprising, while the vehicle is at the standstill in automatic vehicle hold mode and one-pedal mode, deactivating the automatic vehicle hold mode and activate one-pedal mode in response to depression of the accelerator pedal.

18. The method as set forth in claim 13:
wherein activating automatic vehicle hold mode to maintain the vehicle at the standstill includes activating automatic vehicle hold mode to maintain the vehicle at the standstill while the vehicle is in one-pedal mode; and
further comprising deactivating the one-pedal mode in response to the depression of the brake pedal to a position that maintains the vehicle at the standstill after deactivation of the automatic vehicle hold mode.

19. The method as set forth in claim 18, further comprising, while the vehicle is in automatic vehicle hold mode and one-pedal mode, deactivating the automatic vehicle hold mode and activate one-pedal mode in response to depression of the accelerator pedal.

20. The method as set forth in claim 13, further comprising preventing the deactivation of the automatic vehicle hold mode in response to depression of the brake pedal when the vehicle is on an incline greater than a threshold.
